(19) United States
(12) Patent Application Publication
(10) Pub. No.: US 2026/0353031 A1
(43) Pub. Date: Nov. 5, 2026

(54) SYSTEM AND METHOD FOR DETERMINING A CONNECTIVITY SCORE FOR AREAMETRIC TILES IN A GEOSPATIAL DATASET

(71) Applicant: GM GLOBAL TECHNOLOGY OPERATIONS LLC, Detroit, MI (US)

(72) Inventors: Rajaneesh K. Mutyalapati, Ajax (CA); Feyijimi Adegbohun, Pflugerville, TX (US)

(73) Assignee: GM GLOBAL TECHNOLOGY OPERATIONS LLC, Detroit, MI (US)

(21) Appl. No.: 19/198,731

(22) Filed: May 5, 2025

(51) Int. Cl. H04W 4/021; B60W 50/14; G05D 1/225; H04W 4/40

(52) U.S. Cl. CPC H04W 4/021; B60W 50/14; G05D 1/225; H04W 4/40

(57) ABSTRACT

A system and method are provided for computing a connectivity score for each areametric tile in a geospatial dataset. A vehicle location is identified, one or more targeted areametric tiles are identified, information is received or accessed relating to parameters that impact connectivity between the vehicle and a cloud-based back office, and a connectivity score is determined for each of the targeted areametric tiles based on a weighted average of the parameters. Any targeted areametric tile having a connectivity score that is less than a minimum connectivity threshold is characterized as a dead zone that is added to a dynamic dead zone tile list (DDTL), and an action is executed based on the DDTL.

### INTRODUCTION

This disclosure relates to systems and methods for determining a connectivity score for areametric tiles in a geospatial dataset.

Self-driving or assisted-driving automotive vehicles utilize digital maps of the surrounding terrain to help drive the vehicle. For example, these digital maps may include geohash information, relating to rectangular geohash tiles of various sizes.

A geo-queue is a prioritized list of geohash tiles (or other areametric tiles) that the vehicle is set to download based on various heuristics performed on the vehicle. In a static geo-queue-based system, the performance or map availability is highly variable due to network congestion and connectivity issues. When a vehicle enters an area where there is a prolonged lack of network coverage, the static geo-queue may not be able to download all the necessary tiles for the drive. A brute-force approach that attempts to download all possible tiles increases the data cost when the system is scaled.

### SUMMARY

According to one embodiment, a method is provided for determining a respective connectivity score for each of a plurality of areametric tiles in a geospatial dataset. The method includes: (i) identifying a vehicle location of an automotive vehicle; (ii) identifying one or more targeted areametric tiles which include one or more of a current areametric tile in which the vehicle location is located, one or more surrounding areametric tiles immediately surrounding the current areametric tile, and one or more upcoming areametric tiles through which the automotive vehicle is anticipated to travel; (iii) receiving or accessing information for each of the targeted areametric tiles relating to a plurality of parameters that impact connectivity between the automotive vehicle and a cloud-based back office; (iv) determining the respective connectivity score for each of the targeted areametric tiles based on a weighted average of the plurality of parameters; (v) determining which of the targeted areametric tiles have respective connectivity scores that are less than a minimum connectivity threshold, thereby defining each of such targeted areametric tiles as a dead zone; (vi) adding each dead zone to a dynamic dead zone tile list (DDTL); and (vii) executing an action based on the DDTL, wherein the action includes one or more of transmitting the DDTL to the automotive vehicle, prefetching map data for the targeted areametric tiles, and urging a change in an operating state of the automotive vehicle.

Each of the areametric tiles may be an L5 geohash tile.

The plurality of areametric tiles may include one or more large geohash tiles and one or more small geohash tiles, wherein each large geohash tile has a first geohash having a first quantity of alphanumeric characters, and each small geohash tile has a second geohash having a second quantity of alphanumeric characters that is larger than the first quantity.

The plurality of parameters may include, for each targeted areametric tile, two or more of a cellular network signal strength, a vehicle-reported signal quality/strength, a weather-related signal interference, and a signal obstruction impact. Each of the parameters may have a respective weight, and the weighted average may be a sum of the parameters multiplied by their respective weights. For each of the targeted areametric tiles, the connectivity score may be represented by C, the parameters may be represented by a first set {P₁, P₂, P₃, P₄, . . . }, and the weights may be represented by a second set {w₁, w₂, w₃, w₄, . . . }, wherein C=(w₁×P₁)+(w₂×P₂)+(w₃×P₃)+(w₄×P₄)+ . . . .

Each dead zone may be stored in the DDTL along with its associated parameters.

The method may further include detecting a handshake with the automotive vehicle, wherein the handshake occurs at the beginning of a key cycle of the automotive vehicle.

The change in operating state may include at least one of taking action aimed at increasing one or more of the respective connectivity scores of the targeted areametric tiles, changing one or more conditions relating to an assisted driving mode, and modifying a schedule for one or both of receiving downloads from the back office and sending uploads to the back office.

The taking action may include making a course change aimed at increasing one or more of the respective connectivity scores of the targeted areametric tiles.

The changing one or more conditions may include one or more of enabling the assisted driving mode, disabling the assisted driving mode, and activating a connectivity alert.

The downloads may include one or more of firmware updates, configuration updates and information packages.

The DDTL may be hosted in the cloud-based back office.

Steps (i) through (vii) may be implemented by a controller configured for receiving input signals and sending output signals, wherein each of the input and output signals is one or both of a command signal and a data signal.

According to another embodiment, a method is provided for determining a respective connectivity score for each of a plurality of geohash tiles in a geospatial dataset. The method includes: (i) identifying a vehicle location of an automotive vehicle by using a controller; (ii) identifying one or more targeted geohash tiles by using the controller, wherein the one or more targeted geohash tiles include one or more of a current geohash tile in which the vehicle location is located, one or more surrounding geohash tiles immediately surrounding the current geohash tile, and one or more upcoming geohash tiles through which the automotive vehicle is anticipated to travel; (iii) receiving or accessing information for each of the targeted geohash tiles by using the controller, wherein the information relates to a plurality of parameters that impact connectivity between the automotive vehicle and a cloud-based back office; (iv) determining the respective connectivity score for each of the targeted geohash tiles by using the controller, wherein the connectivity score is based on a weighted average of the plurality of parameters; (v) determining which of the targeted geohash tiles have respective connectivity scores that are less than a minimum connectivity threshold by using the controller, thereby defining each of such targeted geohash tiles as a dead zone; (vi) adding each dead zone to a dynamic dead zone tile list (DDTL) by using the controller; and (vii) executing an action based on the DDTL by using the controller, wherein the action includes one or more of transmitting the DDTL to the automotive vehicle, prefetching map data for the targeted geohash tiles, and urging a change in an operating state of the automotive vehicle.

According to yet another embodiment, a system is provided for determining a respective connectivity score for each of a plurality of areametric tiles in a geospatial dataset. The system includes: (i) a locating module configured for identifying a vehicle location of an automotive vehicle; (ii) a targeting module configured for identifying one or more targeted areametric tiles which includes one or more of a current areametric tile in which the vehicle location is located, one or more surrounding areametric tiles immediately surrounding the current areametric tile, and one or more upcoming areametric tiles through which the automotive vehicle is anticipated to travel; (iii) a receiving module configured for receiving or accessing information for each of the targeted areametric tiles relating to a plurality of parameters that impact connectivity between the automotive vehicle and a cloud-based back office; (iv) a scoring module configured for determining the respective connectivity score for each of the targeted areametric tiles based on a weighted average of the plurality of parameters; (v) a comparing module configured for determining which of the targeted areametric tiles have respective connectivity scores that are less than a minimum connectivity threshold, thereby defining each of such targeted areametric tiles as a dead zone; (vi) an adding module configured for adding each dead zone to a dynamic dead zone tile list (DDTL); (vii) an executing module configured for executing an action based on the DDTL, wherein the action includes one or more of transmitting the DDTL to the automotive vehicle, prefetching map data for the targeted areametric tiles, and urging a change in an operating state of the automotive vehicle; and (viii) a controller operatively connected with the locating module, the targeting module, the receiving module, the scoring module, the comparing module, the adding module and the executing module, wherein the controller is configured for one or both of (a) receiving input signals from one or more of the locating, targeting, receiving, scoring, comparing, adding and executing modules, and (b) sending output signals to one or more of the locating, targeting, receiving, scoring, comparing, adding and executing modules.

The system may further include a detecting module configured for detecting a handshake with the automotive vehicle, wherein the controller is further operatively connected with the detecting module and is further configured for one or both of receiving input signals from the detecting module and sending output signals to the detecting module. Each of the input and output signals may be one or both of a command signal and a data signal.

The DDTL may be hosted in the cloud-based back office.

The plurality of parameters may include, for each targeted areametric tile, two or more of a cellular network signal strength, a vehicle-reported signal quality/strength, a weather-related signal interference, and a signal obstruction impact, each of the parameters may have a respective weight, and the weighted average may be a sum of the parameters multiplied by their respective weights.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic diagram of a vehicle in communication with a cloud-based back office.

FIG. 2 is a map showing a selected L4 geohash tile.

FIG. 3 shows the same map as FIG. 2, but subdivided into thirty-two L5 geohash tiles.

FIG. 4 is a schematic diagram of a selection of L5 geohash tiles in a geospatial dataset with trouble zones superimposed thereon.

FIG. 5 is a schematic diagram of just the right side of FIG. 4, showing an anticipated vehicle path.

FIG. 6 is a word diagram comparing a large L4 geohash tile with a small L5 geohash tile.

FIG. 7 is a group of equations describing a first set of parameters, a second set of weights, and an equation for calculating a connectivity score.

FIG. 8 is a flowchart of a method for determining a connectivity score for areametric tiles in a geospatial dataset.

FIG. 9 is a block diagram of a system for determining a connectivity score for areametric tiles in a geospatial dataset.

### DETAILED DESCRIPTION

Referring now to the drawings, wherein like numerals indicate like parts in the several views, a system 20 and a method 100 for determining a connectivity score C for areametric tiles 14 in a geospatial dataset 19 are shown and described herein.

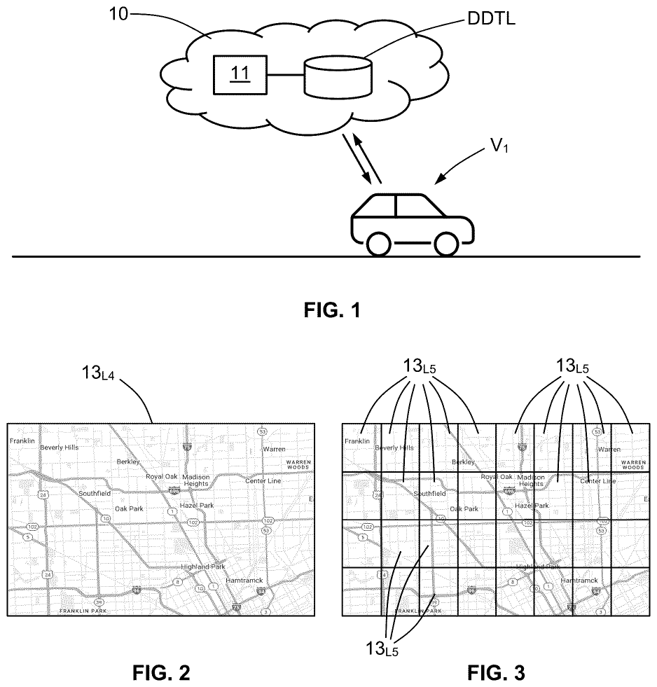

FIG. 1 shows a schematic diagram of an automotive vehicle V₁ that is in communication with the cloud 10 (i.e., the internet), such as through cellular phone signal, radio or other electromagnetic frequencies. In some embodiments, the automotive vehicle V₁ may be capable of operating in an assisted-driving mode (which may optionally include a fully self-driving mode). A cloud-based back office 11 is present or hosted within the cloud 10. A dynamic dead zone tile list or “DDTL” (described in further detail below) is also present or hosted within the cloud 10, with the back office 11 having access to the DDTL.

FIG. 2 shows a road map bounded by a rectangle, where the rectangle encloses a selected L4 geohash tile 13_{L4}. In comparison, FIG. 3 shows a map of the same area as FIG. 2, but with the map being subdivided into thirty-two smaller L5 geohash tiles 13_{L5}. Both the L4 geohash tile 13_{L4} and the L5 geohash tiles 13_{L5} are examples of geohash tiles 13.

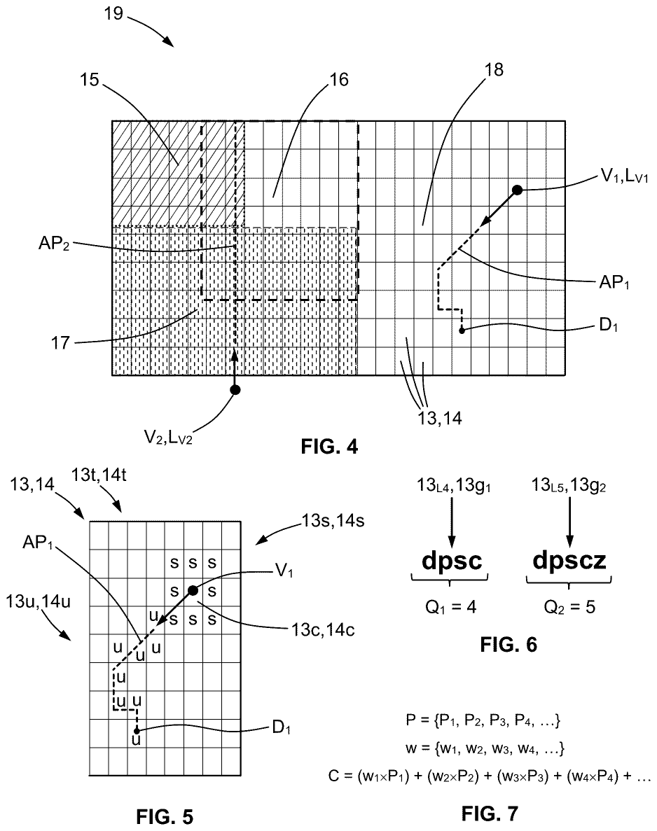

FIG. 4 shows a schematic diagram of a selection of areametric tiles 14—for example, geohash tiles 13—but without any road map being shown. The collection of areametric tiles 14 represent a portion of a much larger geospatial dataset 19, such as the global collection of areametric tiles 14 that cover the planet Earth. While FIGS. 2-4 specifically reference L4 and/or L5 geohash tiles 13_{L4}, 13_{L5}, it should be noted that the scope of the present disclosure is not limited to L4 and L5 geohash tiles 13_{L4}, 13_{L5}, nor is it limited to the system or hierarchy of geohash tiles 13, but may also extend to any areametric way of dividing up the geospatial dataset 19 of the Earth's surface into smaller, organized subdivisions, such as hexagonal H3 tiles/coordinates, maritime tiles/coordinates, slippy tiles, and the like. As used herein, an “areametric” tile 14 is a region, plot, sector or tile of the Earth's surface having defined boundaries enclosing a defined area. Each of such areametric tiles 14 may have its own unique identifier, location, hash, handle or the like which identifies and differentiates it from all other areametric tiles 14 of the same type. Thus, while the system 20 and method 100 of the present disclosure are described at some points herein in terms of geohash tiles 13, this is merely for exemplary purposes, and the scope of areametric tiles 14 is not limited to geohash tiles 13.

Superimposed on the selection of geohash or areametric tiles 13, 14 in FIG. 4 are several “trouble zones”, where connectivity between the back office 11 and one or more automotive vehicles V₁, V₂ in those trouble zones has been compromised in one or more ways. For example, a first trouble zone 15 is shown in the upper-left of the drawing, bounded by dotted lines and having diagonal cross-hatching. This first trouble zone 15 may be an area experiencing a network outage. A second trouble zone 16 is shown just to the right of and overlapping with the first trouble zone 15. This second trouble zone 16 is bounded by large, heavy dashed lines, and may be an area experiencing poor network coverage. A third trouble zone 17 is shown in the lower-left of the drawing, and overlaps with a portion of the second trouble zone 16. This third trouble zone 17 is bounded by small, light dashed lines and is filled with stippling; this may be an area experiencing high-speed vehicle telemetry (HSVT) connectivity issues or failures, which overlaps with a portion of the second trouble zone 16. (These HSVT issues or failures may relate to any type of communication between a vehicle V₁ and a remote server, such as the back office 11, where the vehicle V₁ reports time-stamped telemetry data of various types, such as its location, speed and heading, the strength of connectivity or quality of signal as measured by the vehicle V₁, etc.) Finally, a fourth zone 18—but not a “trouble” zone—is shown on the right of the drawing, where satisfactory connectivity (i.e., no significant “trouble”) is provided.

As illustrated in FIG. 4, a first vehicle V₁ having a first vehicle location L_{V1} is shown within the fourth zone 18, with a current travel direction vector pointing downward and to the left. This first vehicle V₁ is within an area where the immediate geohash or areametric tile 13, 14, as well as those surrounding the first vehicle V₁ and along the vehicle's first anticipated path AP₁, are all within the fourth zone 18 where good network connectivity is provided. In contrast, a second vehicle V₂ having a second vehicle location L_{V2} is shown at the bottom-left of the drawing, where the second vehicle V₂ is headed along a second anticipated path AP₂ (indicated by the upward arrow) where the second vehicle V₂ will soon reach the third trouble zone 17 in which there are HSVT connectivity/telemetry issues or failures. If this second vehicle V₂ continues along the indicated path AP₂, it may also encounter additional connectivity issues as it travels across the first and/or second trouble zones 15, 16 as well.

In this example, if the first and second vehicles V₁, V₂ are in a self-driving or assisted-driving mode (or the driver wishes to enter into one of these modes), then it would be beneficial for the driver and the self-driving or assisted-driving system to be aware that the first or second vehicle V₁, V₂ is either already in a trouble zone, or is about to enter a trouble zone, since some types of network connectivity issues may affect the ability of the self-driving or assisted-driving system to function properly.

FIG. 5 shows a schematic diagram of just the right side of FIG. 4, showing the anticipated path AP₁ and destination Di of the first vehicle V₁. As noted above, the individual tiles may be various types and sizes of areametric tiles 14, such as geohash tiles 13. As illustrated in the drawing, various types of targeted areametric tiles 14t (e.g., targeted geohash tiles 13t) are shown. The tile within which the first vehicle V₁ and the first vehicle location L_{V1} are currently located may be called a current areametric tile 14c (e.g., a current geohash tile 13c), and the tiles surrounding the current areametric or geohash tile 14c, 13c may be called surrounding areametric or geohash tiles 14s, 13s. These surrounding tiles 13s, 14s may include tiles that border or touch the current tile 13c, 14c, and may optionally also include tiles that are spaced one or more tiles away from the current tile 13c,14c. Along the anticipated path AP₁ of the vehicle V₁, one or more upcoming areametric or geohash tiles 14u, 13u may be found. In FIG. 5, note that the surrounding tiles 13s, 14s have a lowercase “s” within each tile, while the upcoming tiles 13u, 14u have a lowercase “u” within each tile.

As seen from FIGS. 2-4, each map or geographical region may be broken up into rectangular (or other other-shaped) tiles of various sizes. For example, the map shown in FIGS. 2 and 3 indicates that a single large geohash tile 13 may be broken up into thirty-two smaller geohash tiles 14. Although not shown in the drawings, an L5 geohash tile 14 may be broken up into thirty-two L6 geohash tiles, and those may be further broken down into even smaller L7 geohash tiles, and so on. Note that as used herein, the terms “large”, “larger”, “small” and “smaller” may be used to differentiate two different tiles by their respective sizes; thus, a “large” tile will be bigger than a “small” tile, and a “small” tile will be littler than a “large” tile.

Each geohash tile 13 has an associated “geohash identifier”, often referred to as simply a “geohash”. For example, FIG. 6 shows a word diagram comparing a first geohash 13g₁ associated with a larger L4 geohash tile 13_{L4} versus a second geohash 13g₂ associated with a smaller L5 geohash tile 13_{L5}. In this example, the larger L4 geohash tile 13_{L4} has a first geohash 13g₁ of “dpsc”, which is four alphanumeric characters long, while the smaller L5 geohash tile 13_{L5} has a second geohash 13g₂ of “dpscz”, which is five alphanumeric characters long. Further, TABLE 1 below shows a breakdown of all thirty-two of the five-digit L5 geohashes 13g₂ which are part of the “dpsc” first geohash 13g₁, arranged in four rows and eight columns.

TABLE 1
L5 Geohashes Within L4 Geohash “dpsc”

| | 1^{st} | 2^{nd} | 3^{rd} | 4^{th} | 5^{th} | 6^{th} | 7^{th} | 8^{th} |
|---|---|---|---|---|---|---|---|---|
| | Col. | Col. | Col. | Col. | Col. | Col. | Col. | Col. |
| 4^{th} | dpscb | dpscc | dpscf | dpscg | dpscu | dpscv | dpscy | dpscz |
| Row | | | | | | | | |
| 3^{rd} | dpsc8 | dpsc9 | dpscd | dpsce | dpscs | dpsct | dpscw | dpscx |
| Row | | | | | | | | |
| 2^{nd} | dpsc2 | dpsc3 | dpsc6 | dpsc7 | dpsck | dpscm | dpscq | dpscr |
| Row | | | | | | | | |
| 1^{st} | dpsc0 | dpsc1 | dpsc4 | dpsc5 | dpsch | dpscj | dpscn | dpscp |
| Row | | | | | | | | |

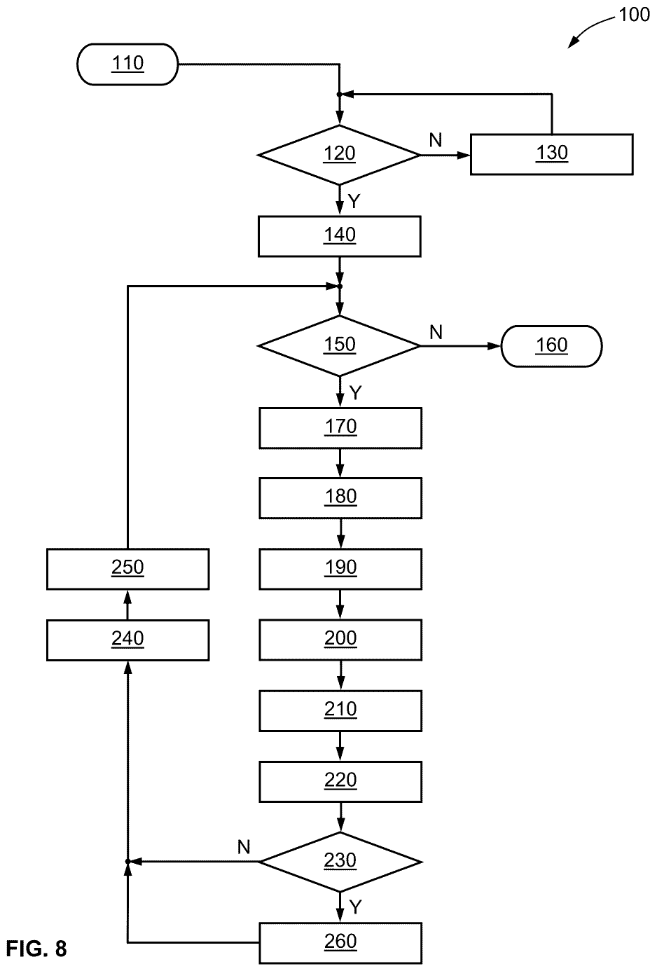

Utilizing the foregoing information about areametric tiles 14 and connectivity concerns, a method 100 may be produced for determining a connectivity score C for the various areametric tiles 14 that are within a geospatial dataset 19. FIG. 7 shows a group of equations which may be utilized with such a method 100, and FIG. 8 shows a flowchart of the method 100. The method 100 may be executed by the back office 11, by an individual automotive vehicle V₁, by a group of automotive vehicles V₁, V₂, or by some combination of the foregoing.

The method 100 starts at block 110, and at block 120, a determination is made as to whether a handshake HS has been detected from the automotive vehicle V₁ (e.g., by the back office 11). The handshake HS may occur at the beginning of each key cycle KC of the automotive vehicle V₁. If a handshake HS with a vehicle V₁ has not been detected, then an optional first delay may be executed at block 130; this optional delay may be included so as to reduce the frequency of having block 120 execute. On the other hand, if a handshake HS has been detected, then the process flow proceeds onward to block 140.

At block 140, a “prior DDTL” may be initialized (i.e., set to an empty set), and at block 150 a determination is made as to whether the vehicle V₁ is still connected (e.g., to the back office 11). The presence of such a connection indicates that the vehicle V₁ is still in its current key cycle KC. If the vehicle V₁ is not still connected, then the method 100 ends at block 160, but if it is still connected, then the process moves on to block 170.

At block 170, a vehicle location L_{V1} of the automotive vehicle V₁ is identified, and at block 180, one or more targeted areametric tiles 14t are identified. The targeted areametric tiles 14t may include a current areametric tile 14c in which the vehicle V₁ and vehicle location L_{V1} are located, one or more surrounding areametric tiles 14s immediately surrounding the current areametric tile 14c, and/or one or more upcoming areametric tiles 14u through which the vehicle V₁ is anticipated or expected to travel.

At block 190, information 12 relating to various parameters P that impact connectivity are received or accessed. These parameters P may include the cellular network signal strength P₁ (as reported by one or more carriers/providers for an area or region), a vehicle-reported signal quality and/or signal strength P₂ (as measured at and reported by one or more vehicles V₁, V₂, etc.), a weather-related signal interference P₃, and a signal obstruction impact P₄, as well as others. The vehicle-reported signal quality/strength P₂ may reflect the actual cellular network signal strength and/or other network parameter(s), as measured by each vehicle V₁, V₂, etc. at their respective locations and times. These other network parameters may include download speed, upload speed, latency, bandwidth, quality of service, and the like. Since the actual cellular network signal strength and/or other network parameters may be reported by multiple vehicles at multiple locations over multiple times, these data points may form or represent a multi-dimensional matrix of parametric values. In order to distill these various data points into a single usable value, the vehicle-reported signal quality/strength P₂ may be an average, a median, a mode or some other measure or combination of these various data points. The weather-related signal interference P₃ may reflect levels and/or types of terrestrial and space weather phenomena that interfere with network connectivity, such as thunderstorms, sunspot activity, and the like. The signal obstruction impact P₄ may reflect the proximity, height and quantity or density of obstructions or obstructive driving situations, such as buildings, mountains, traveling within tunnels, etc. The specific values of these parameters P may vary from one small areametric tile 14 to another.

At block 200, a respective current connectivity score C is determined for each of the targeted areametric tiles 14t. The connectivity score C is based on a weighted average of the various abovementioned parameters P, with each of the parameters P having a respective weight w. The weighted average may be calculated as a sum of the parameters P multiplied by their respective weights w. For example, for each of the targeted areametric tiles 14t, the connectivity score may be represented by C, the parameters P may be represented by a first set {P₁, P₂, P₃, P₄, . . . }, and the weights w may be represented by a second set {w₁, w₂, w₃, w₄, . . . }, wherein C=(w₁×P₁)+(w₂×P₂)+(w₃×P₃)+(w₄×P₄)+ . . . . However, while this example utilizes four parameters P and weights w, it may be noted that only two parameters P and weights w are needed in order to calculate the connectivity score C, and any number of parameters P and corresponding weights w greater than two may be used.

At block 210, a determination is made as to which of the targeted areametric tiles 14t have a connectivity score C that is less than a minimum connectivity threshold Cₘᵢₙ, thereby defining each of such targeted areametric tiles 14t as a dead zone DZ, in which network connectivity issues may be experienced.

At block 220, any dead zones DZ that are found are added to a dynamic dead zone tile list DDTL—e.g., a “current DDTL”—which is a collection of all the current dead zones DZ found within the targeted areametric tiles 14t. Each dead zone DZ may be stored in the DDTL along with the specific values of its associated parameters P.

At block 230, a check is made as to whether the current DDTL is different from the prior DDTL. If not, then the process flows onto block 240 where the prior DDTL is set to equal the current DDTL, and an optional second delay may be performed at block 250. However, if the current DDTL is different from the prior DDTL, then the process moves on to block 260 where an action based on the current DDTL is executed.

The action taken in block 260 may include one or more of transmitting the DDTL to the automotive vehicle V₁, prefetching map data for the targeted areametric tiles 14t, and urging a change in an operating state of the automotive vehicle V₁.

The change in operating state may include at least one of taking action aimed at increasing one or more of the respective connectivity scores C of the targeted areametric tiles 14t, changing one or more conditions relating to an assisted driving mode, and modifying a schedule for one or both of receiving downloads from the back office 11 and sending uploads to the back office 11. The downloads may include one or more of firmware updates, configuration updates and information packages.

The taking action may include making a course change (i.e., a steering change, so as to follow a different path) aimed at increasing one or more of the respective connectivity scores C of the targeted areametric tiles 14t.

The changing one or more conditions may include one or more of enabling the assisted driving mode, disabling the assisted driving mode, and activating a connectivity alert (e.g., a light on the steering wheel or on the instrument panel, sounding an audible alert, etc.).

The method 100 may be executed again at the beginning of the next key cycle KC of the automotive vehicle V₁, or at any other desired time or frequency. The dead zone DZ information that is stored in the DDTL may be used for a variety of purposes, such as for assisted or fully autonomous driving, as well as for navigation, course correction, managing the upload and download of firmware patches/updates, configuration patches/updates, information packages, map data, or the like.

Also note that even when no handshake HS with a vehicle V₁ is detected, the cloud-based back office 11 may still carry on a process of data collection, analysis and aggregation so as to build a very large DDTL of dead zones DZ covering a wide area and/or multiple areas. The back office 11 may accomplish this by receiving or accessing information 12 pertaining to the various parameters P for the areametric tiles 14 that are within the wide area/multiple areas (at block 190), determining the connectivity scores C for these areametric tiles 14 (at block 200), determining which tiles 14 have connectivity scores C that are less than a minimum connectivity threshold Cₘᵢₙ (at block 210), and adding these less-than-minimum tiles 14 as dead zones DZ to the very large DDTL (at block 220).

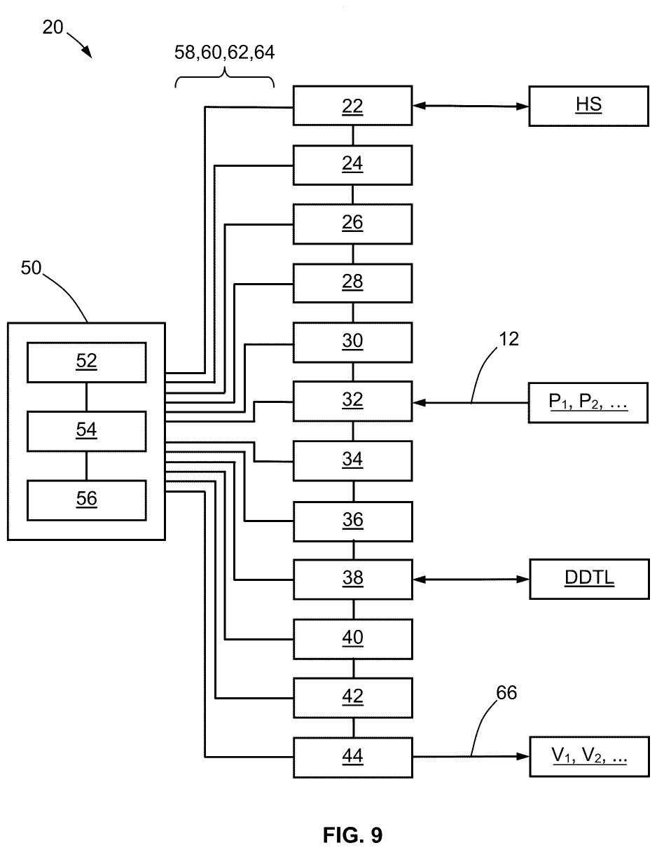

FIG. 9 shows a block diagram of a system 20 for determining the connectivity score C for areametric tiles 14 in a geospatial dataset 19. The system 20 includes a locating module 28, a targeting module 30, a receiving module 32, a scoring module 34, a comparing module 36, an adding module 38, an executing module 44 and a controller 50. The system 20 may optionally include various other modules as well, as described below.

The locating module 28 is configured for identifying a vehicle location L_{V1} of an automotive vehicle V₁.

The targeting module 30 is configured for identifying one or more targeted areametric tiles 14t, which includes a current areametric tile 14c in which the vehicle location L_{V1} is located, one or more surrounding areametric tiles 14s immediately surrounding the current areametric tile 14c, and/or one or more upcoming areametric tiles 14u through which the automotive vehicle V₁ is anticipated to travel.

The receiving module 32 is configured for receiving or accessing information 12 for each of the targeted areametric tiles 14t relating to the various parameters P that impact connectivity between the automotive vehicle V₁ and the back office 11.

The scoring module 34 is configured for determining the connectivity score C for each of the targeted areametric tiles 14 based on a weighted average of the parameters P.

The comparing module 36 is configured for determining which of the targeted areametric tiles 14t have respective connectivity scores C that are less than a minimum connectivity threshold Cₘᵢₙ, thereby defining each of such targeted areametric tiles 14t as a dead zone DZ.

The adding module 38 is configured for adding any dead zones DZ to a dynamic dead zone tile list DDTL.

The executing module 44 is configured for executing an action based on the DDTL. This action may include one or more of transmitting the DDTL to the automotive vehicle V₁, prefetching map data for the targeted areametric tiles 14t, and urging a change in an operating state of the automotive vehicle V₁.

The controller 50 is operatively connected with the locating module 28, the targeting module 30, the receiving module 32, the scoring module 34, the comparing module 36, the adding module 28 and the executing module 44. The controller 50 is configured for receiving input signals 58 from one or more of the locating, targeting, receiving, scoring, comparing, adding and executing modules 28, 30, 32, 34, 36, 38, 44, or for sending output signals 60 to one or more of the locating, targeting, receiving, scoring, comparing, adding and executing modules 28, 30, 32, 34, 36, 38, 44, or for both receiving and sending. The controller 50 may include a processor 52 operatively connected with a memory 54 in which instructions 56 are stored. For example, the instructions 56 may include or be based on the steps of the method 100 as described above.

Optionally, the system 20 may further include a detecting module 22 configured for detecting a handshake HS with the automotive vehicle V₁. In this arrangement, the controller 50 is further operatively connected with the detecting module 22, and the controller 50 is further configured for receiving input signals 58 from the detecting module 22, or for sending output signals 60 to the detecting module 22, or for both receiving and sending.

Each of the input and output signals 58, 60 may be one or both of a command signal 62 and a data signal 64. Note that in FIG. 8, connections are shown between neighboring modules 22, 24, 26, 28, 30, 32, 34, 36, 38, 40, 42, 44 and between the controller 50 and each of the modules 22, 24, 26, 28, 30, 32, 34, 36, 38, 40, 42, 44; however, it should be noted that some of these connections may be optional. For example, when the receiving module 32 receives or accesses information 12 relating to the various parameters P, it may pass this information 12 directly to the scoring module 34, or it may route the information 12 to the controller 50 which then routes the information 12 to the scoring module 34.

The various configurations and embodiments of the system 20 and method 100 presented herein may be implemented in multiple different applications and use cases, including use with electric or hybrid automotive vehicles. For example, the system 20 and method 100 may be implemented on-board such vehicles, or they may be implemented off-board such vehicles, or some portions may be implemented on-board while other portions may be implemented off-board.

As one having skill in the relevant art will appreciate, the system 20 and method 100 of the present disclosure may be presented or arranged in a variety of different configurations and embodiments.

According to one embodiment, a method 100 is provided for determining a respective connectivity score C for each of a plurality of areametric tiles 14 in a geospatial dataset 19. The method 100 includes: (i) at block 170, identifying a vehicle location L_{V1} of an automotive vehicle V₁; (ii) at block 180, identifying one or more targeted areametric tiles 14t which include one or more of a current areametric tile 14c in which the vehicle location L_{V1} is located, one or more surrounding areametric tiles 14s immediately surrounding the current areametric tile 14c, and one or more upcoming areametric tiles 14u through which the automotive vehicle V₁ is anticipated to travel; (iii) at block 190, receiving or accessing information 12 for each of the targeted areametric tiles 14t relating to a plurality of parameters P that impact connectivity between an automotive vehicle V₁ and a cloud-based back office 11; (iv) at block 200, determining the respective connectivity score C for each of the targeted areametric tiles 14t based on a weighted average of the plurality of parameters P; (v) at block 210, determining which of the targeted areametric tiles 14t have respective connectivity scores C that are less than against a minimum connectivity threshold Cₘᵢₙ, thereby defining each of such targeted areametric tiles 14t as a dead zone DZ; (vi) at block 220, adding each dead zone DZ to a dynamic dead zone tile list DDTL; and (vii) at block 260, executing an action based on the DDTL, wherein the action includes one or more of transmitting the DDTL to the automotive vehicle V₁, prefetching map data for the targeted areametric tiles 14t, and urging a change in an operating state of the automotive vehicle V₁.

Each of the areametric tiles 14 may be an L5 geohash tile 13_{L5}.

The plurality of areametric tiles 14 may include one or more large geohash tiles 13_{L4} and one or more small geohash tiles 13_{L5}, wherein each large geohash tile 13_{L4} has a first geohash 13g₁ having a first quantity Q₁ of alphanumeric characters, and each small geohash tile 13_{L5} has a second geohash 13g₂ having a second quantity Q₂ of alphanumeric characters that is larger than the first quantity Q₁.

The plurality of parameters P may include, for each targeted areametric tile 14t, two or more of a cellular network signal strength P₁, a vehicle-reported signal quality/strength P₂, a weather-related signal interference P₃, and a signal obstruction impact P₄. Each of the parameters P may have a respective weight w, and the weighted average may be a sum of the parameters P multiplied by their respective weights w. For each of the targeted areametric tiles 14t, the connectivity score may be represented by C, the parameters P may be represented by a first set {P₁, P₂, P₃, P₄, . . . }, and the weights w may be represented by a second set {w₁, w₂, w₃, w₄, . . . }, wherein C=(w₁×P₁)+(w₂×P₂)+(w₃×P₃)+(w₄×P₄)+ . . . .

Each dead zone DZ may be stored in the DDTL along with its associated parameters P.

The method 100 may further include: (v) at block 120, detecting a handshake HS with the automotive vehicle V₁, wherein the handshake HS occurs at the beginning of each key cycle KC of the automotive vehicle V₁.

The change in operating state may include at least one of taking action aimed at increasing one or more of the respective connectivity scores C of the targeted areametric tiles 14t, changing one or more conditions relating to an assisted driving mode, and modifying a schedule for one or both of receiving downloads from the back office 11 and sending uploads to the back office 11.

The taking action may include making a course change aimed at increasing one or more of the respective connectivity scores C of the targeted areametric tiles 14t.

The changing one or more conditions may include one or more of enabling the assisted driving mode, disabling the assisted driving mode, and activating a connectivity alert.

The downloads may include one or more of firmware updates, configuration updates and information packages.

The DDTL may be hosted in the cloud-based back office 11.

Steps (i) through (vii) may be implemented by a controller 50 configured for receiving input signals 58 and sending output signals 60, wherein each of the input and output signals 58, 60 is one or both of a command signal 62 and a data signal 64.

According to another embodiment, a method 100 is provided for determining a respective connectivity score C for each of a plurality of geohash tiles 13 in a geospatial dataset 19. The method 100 includes: (i) identifying a vehicle location L_{V1} of an automotive vehicle V₁ by using a controller 50; (ii) identifying one or more targeted geohash tiles 13t by using the controller 50, wherein the one or more targeted geohash tiles 13t include one or more of a current geohash tile 13c in which the vehicle location L_{V1} is located, one or more surrounding geohash tiles 13s immediately surrounding the current geohash tile 13c, and one or more upcoming geohash tiles 13u through which the automotive vehicle V₁ is anticipated to travel; (iii) at block 190, receiving or accessing information 12 for each of the targeted geohash tiles 13t by using the controller 50, wherein the information 12 relates to a plurality of parameters P that impact connectivity between an automotive vehicle V₁ and a cloud-based back office 11; (iv) at block 200, determining the respective connectivity score C for each of the targeted geohash tiles 13t by using the controller 50, wherein the connectivity score C is based on a weighted average of the plurality of parameters P; (v) at block 210, determining which of the targeted geohash tiles 13t have respective connectivity scores C that are less than a minimum connectivity threshold Cₘᵢₙ by using the controller 50, thereby defining each of such targeted geohash tiles 13t as a dead zone DZ; (vi) at block 220, adding each dead zone DZ to a dynamic dead zone tile list DDTL by using the controller 50; (vii) at block 260, executing an action based on the DDTL by using the controller 50, wherein the action includes one or more of transmitting the DDTL to the automotive vehicle V₁, prefetching map data for the targeted geohash tiles 13t, and urging a change in an operating state of the automotive vehicle V₁.

According to yet another embodiment, a system 20 is provided for determining a respective connectivity score C for each of a plurality of areametric tiles 14 in a geospatial dataset 19. The system 20 includes: (i) a locating module 28 configured for identifying a vehicle location L_{V1} of an automotive vehicle V₁; (ii) a targeting module 30 configured for identifying one or more targeted areametric tiles 14t which includes one or more of a current areametric tile 14c in which the vehicle location L_{V1} is located, one or more surrounding areametric tiles 14s immediately surrounding the current areametric tile 14c, and one or more upcoming areametric tiles 14u through which the automotive vehicle V₁ is anticipated to travel; (iii) a receiving module 32 configured for receiving or accessing information 12 for each of the targeted areametric tiles 14t relating to a plurality of parameters P that impact connectivity between the automotive vehicle V₁ and a cloud-based back office 11; (iv) a scoring module 34 configured for determining the respective connectivity score C for each of the targeted areametric tiles 14t based on a weighted average of the plurality of parameters P; (v) a comparing module 36 configured for determining which of the targeted areametric tiles 14t have respective connectivity scores C that are less than a minimum connectivity threshold Cₘᵢₙ, thereby defining each of such targeted areametric tiles 14t as a dead zone DZ; (vi) an adding module 38 configured for adding each dead zone DZ to a dynamic dead zone tile list DDTL; (vii) an executing module 44 configured for executing an action based on the DDTL, wherein the action includes one or more of transmitting the DDTL to the automotive vehicle V₁, prefetching map data for the targeted areametric tiles 14t, and urging a change in an operating state of the automotive vehicle V₁; and (viii) a controller 50 operatively connected with the location module 28, the targeting module 30, the receiving module 32, the scoring module 34, the comparing module 36, the adding module 38, and the executing module 44, wherein the controller 50 is configured for one or both of (a) receiving input signals 46 from one or more of the locating, targeting, receiving, scoring, comparing, adding and executing modules 28, 30, 32, 34, 36, 38, 44, and (b) sending output signals 48 to one or more of the locating, targeting, receiving, scoring, comparing, adding and executing modules 28, 30, 32, 34, 36, 38, 44.

The system 20 may further include a detecting module 22 configured for detecting a handshake HS with the automotive vehicle V₁, wherein the controller 50 is further operatively connected with the detecting module 22 and is further configured for one or both of receiving input signals 58 from the detecting module 22 and sending output signals 60 to the detecting module 22. Each of the input and output signals 58, 60 may be one or both of a command signal 62 and a data signal 64.

The DDTL may be hosted in the cloud-based back office 11.

The plurality of parameters P may include, for each targeted areametric tile 14t, two or more of a cellular network signal strength P₁, a vehicle-reported signal quality/strength P₂, a weather-related signal interference P₃, and a signal obstruction impact P₄, each of the parameters P₁, P₂, P₃, P₄ may have a respective weight w₁, w₂, w₃, w₄, and the weighted average may be a sum of the parameters P₁, P₂, P₃, P₄ multiplied by their respective weights w₁, w₂, w₃, w₄.

While various steps of the method 100 have been described as being separate blocks, and various functions of the system 20 have been described as being separate modules or elements, it may be noted that two or more steps may be combined into fewer blocks, and two or more functions may be combined into fewer modules or elements. Similarly, some steps described as a single block may be separated into two or more blocks, and some functions described as a single module or element may be separated into two or more modules or elements. Additionally, the order of the steps or blocks described herein may be rearranged in one or more different orders, and the arrangement of the functions, modules and elements may be rearranged into one or more different arrangements.

(As used herein, a “module” may include hardware and/or software, including executable instructions, for receiving one or more inputs, processing the one or more inputs, and providing one or more corresponding outputs. Also note that at some points throughout the present disclosure, reference may be made to a singular input, output, element, etc., while at other points reference may be made to plural/multiple inputs, outputs, elements, etc. Thus, weight should not be given to whether the input(s), output(s), element(s), etc. are used in the singular or plural form at any particular point in the present disclosure, as the singular and plural uses of such words should be viewed as being interchangeable, unless the specific context dictates otherwise.)

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. For purposes of the present description, unless specifically disclaimed, use of the singular includes the plural and vice versa. Additionally, the phrase “at least one of A and B” and the phrase “A and/or B” should each be understood to mean “only A, only B, or both A and B”.

Moreover, unless explicitly stated to the contrary, the words “including”, “containing”, “comprising”, “having” and the like shall mean “including without limitation”, and embodiments including one or more elements having a particular property may include one or more additional of such elements that do not have that property. And when broadly descriptive adverbs such as “substantially” and “generally” are used herein to modify a word or phrase, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, words of approximation such as “about”, “almost”, “approximately” or the like may be used herein in the sense of “at, near, or nearly at”, or “within 0-5% of”, or “within acceptable manufacturing or production tolerances”, or logical combinations thereof. Furthermore, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

As used herein, a component or module that is “configured to” perform a specified function is capable of performing the specified function without alteration, rather than merely having potential to perform the specified function after further modification. In other words, the described component or module, when expressly configured to perform the specified function, is specifically selected, created, implemented, utilized, programmed, and/or designed for the purpose of performing the specified function.

This written description uses examples, including the best mode, to enable those skilled in the art to make and use devices, systems and compositions of matter, and to perform methods, according to this disclosure. It is the following claims, including equivalents, which define the scope of the present disclosure. 1. A method for determining a respective connectivity score for each of a plurality of areametric tiles in a geospatial dataset, comprising:
(i) identifying a vehicle location of an automotive vehicle;
(ii) identifying one or more targeted areametric tiles which include one or more of a current areametric tile in which the vehicle location is located, one or more surrounding areametric tiles immediately surrounding the current areametric tile, and one or more upcoming areametric tiles through which the automotive vehicle is anticipated to travel;
(iii) receiving or accessing information for each of the targeted areametric tiles relating to a plurality of parameters that impact connectivity between the automotive vehicle and a cloud-based back office; .
(iv) determining the respective connectivity score for each of the targeted areametric tiles based on a weighted average of the plurality of parameters;
(v) determining which of the targeted areametric tiles have respective connectivity scores that are less than a minimum connectivity threshold, thereby defining each of such targeted areametric tiles as a dead zone;
(vi) adding each dead zone to a dynamic dead zone tile list (DDTL); and
(vii) executing an action, using a controller, based on the DDTL, wherein the action includes urging a change in an operating state of the automotive vehicle in an assisted driving mode and one or more of transmitting the DDTL to the automotive vehicle and prefetching map data for the targeted areametric tiles.

2. The method of claim 1, wherein each of the areametric tiles is an L5 geohash tile.

3. The method of claim 1, wherein the plurality of areametric tiles includes one or more large geohash tiles and one or more small geohash tiles, wherein each large geohash tile has a first geohash having a first quantity of alphanumeric characters, and each small geohash tile has a second geohash having a second quantity of alphanumeric characters that is larger than the first quantity.

4. The method of claim 1, wherein the plurality of parameters includes, for each targeted areametric tile, two or more of:
a cellular network signal strength;
a vehicle-reported signal quality/strength;
a weather-related signal interference; and
a signal obstruction impact.

5. The method of claim 4, wherein each of the parameters has a respective weight, and wherein the weighted average is a sum of the parameters multiplied by their respective weights.

6. The method of claim 5, wherein for each of the targeted areametric tiles, the connectivity score is represented by C, the parameters are represented by a first set {P₁, P₂, P₃, P₄}, and the weights are represented by a second set {w₁, w₂, w₃, w₄}, wherein C=(w₁ ′ P₁)+(w₂ ′ P₂)+(w₃ ′ P₃)+(w₄ ′ P₄).

7. The method of claim 1, wherein each dead zone is stored in the DDTL along with its associated parameters.

8. The method of claim 1, further comprising:
detecting a handshake with the automotive vehicle;
wherein the handshake occurs at the beginning of a key cycle of the automotive vehicle.

9. The method of claim 1, wherein the change in operating state includes at least one of:
taking action aimed at increasing one or more of the respective connectivity scores of the targeted areametric tiles;
changing one or more conditions relating to the assisted driving mode; and
modifying a schedule for one or both of receiving downloads from the back office and sending uploads to the back office.

10. The method of claim 9, wherein the taking action includes making a course change aimed at increasing one or more of the respective connectivity scores of the targeted areametric tiles.

11. The method of claim 9, wherein the changing one or more conditions includes one or more of enabling the assisted driving mode, disabling the assisted driving mode, and activating a connectivity alert.

12. The method of claim 9, wherein the downloads include one or more of firmware updates, configuration updates and information packages.

13. The method of claim 1, wherein the DDTL is hosted in the cloud-based back office.

14. The method of claim 1, wherein steps (i) through (vii) are implemented by a controller configured for receiving input signals and sending output signals, wherein each of the input and output signals is one or both of a command signal and a data signal.

15. A method for determining a respective connectivity score for each of a plurality of geohash tiles in a geospatial dataset, comprising:
identifying a vehicle location of an automotive vehicle by using a controller;
identifying one or more targeted geohash tiles by using the controller, wherein the one or more targeted geohash tiles include one or more of a current geohash tile in which the vehicle location is located, one or more surrounding geohash tiles immediately surrounding the current geohash tile, and one or more upcoming geohash tiles through which the automotive vehicle is anticipated to travel;
receiving or accessing information for each of the targeted geohash tiles by using the controller, wherein the information relates to a plurality of parameters that impact connectivity between the automotive vehicle and a cloud-based back office;
determining the respective connectivity score for each of the targeted geohash tiles by using the controller, wherein the connectivity score is based on a weighted average of the plurality of parameters;
determining which of the targeted geohash tiles have respective connectivity scores that are less than a minimum connectivity threshold by using the controller, thereby defining each of such targeted geohash tiles as a dead zone;
adding each dead zone to a dynamic dead zone tile list (DDTL) by using the controller; and
executing an action based on the DDTL by using the controller, wherein the action includes urging a change in an operating state of the automotive vehicle in an assisted driving mode and one or more of transmitting the DDTL to the automotive vehicle and prefetching map data for the targeted geohash tiles.

16. A system for determining a respective connectivity score for each of a plurality of areametric tiles in a geospatial dataset, comprising:
a locating module configured for identifying a vehicle location of an automotive vehicle;
a targeting module configured for identifying one or more targeted areametric tiles which includes one or more of a current areametric tile in which the vehicle location is located, one or more surrounding areametric tiles immediately surrounding the current areametric tile, and one or more upcoming areametric tiles through which the automotive vehicle is anticipated to travel;
a receiving module configured for receiving or accessing information for each of the targeted areametric tiles relating to a plurality of parameters that impact connectivity between the automotive vehicle and a cloud-based back office;
a scoring module configured for determining the respective connectivity score for each of the targeted areametric tiles based on a weighted average of the plurality of parameters;
a comparing module configured for determining which of the targeted areametric tiles have respective connectivity scores that are less than a minimum connectivity threshold, thereby defining each of such targeted areametric tiles as a dead zone;
an adding module configured for adding each dead zone to a dynamic dead zone tile list (DDTL);
an executing module configured for executing an action based on the DDTL, wherein the action includes urging a change in an operating state of the automotive vehicle in an assisted driving mode and one or more of transmitting the DDTL to the automotive vehicle and prefetching map data for the targeted areametric tiles; and
a controller operatively connected with the locating module, the targeting module, the receiving module, the scoring module, the comparing module, the adding module and the executing module, wherein the controller is configured for one or both of:
receiving input signals from one or more of the locating, targeting, receiving, scoring, comparing, adding and executing modules; and
sending output signals to one or more of the locating, targeting, receiving, scoring, comparing, adding and executing modules.

17. The system of claim 16, further comprising:
a detecting module configured for detecting a handshake with the automotive vehicle;
wherein the controller is further operatively connected with the detecting module and is further configured for one or both of:
receiving input signals from the detecting module; and
sending output signals to the detecting module.

18. The system of claim 17, wherein each of the input and output signals is one or both of a command signal and a data signal.

19. The system of claim 16, wherein the DDTL is hosted in the cloud-based back office.

20. The system of claim 16, wherein:
the plurality of parameters includes, for each targeted areametric tile, two or more of a cellular network signal strength, a vehicle-reported signal quality/strength, a weather-related signal interference, and a signal obstruction impact;
each of the parameters has a respective weight; and
the weighted average is a sum of the parameters multiplied by their respective weights.
